(19) United States
(12) Patent Application Publication
(10) Pub. No.: US 2017/0051554 A1
(43) Pub. Date: Feb. 23, 2017

(54) SLIDING DOOR SYSTEM

(71) Applicant: Design Synthesis Inc., San Diego, CA (US)

(72) Inventor: David C. Dastrup, Escondido, CA (US)

(21) Appl. No.: 15/239,812

(22) Filed: Aug. 17, 2016

Related U.S. Application Data
(60) Provisional application No. 62/205,827, filed on Aug. 17, 2015.

(51) Int. Cl. E06B 3/46; E05D 15/06

(52) U.S. Cl. CPC E06B 3/4654; E05D 15/0639; E05D 15/0656

(57) ABSTRACT

The invention relates to devices, systems and methods for top-mounting and sliding doors. Specifically, the invention provides hardware for pocket doors that can be assembled and disassembled without damaging finish surfaces of the wall pocket.

### RELATED APPLICATIONS

This application claims the benefit of priority under 35 USC §119 of U.S. Provisional Applications Ser. No. 62/205,827 filed Aug. 17, 2015, the entire disclosure of which is incorporated herein by reference.

### FIELD OF THE INVENTION

The invention relates to devices, systems and methods for top-mounting and sliding doors. Specifically, the invention relates to hardware for pocket doors.

### BACKGROUND

Pocket-door have become increasingly used in the construction of residential and commercial doorways due to the space saving features they offer. A typical hinged door, requires that an arc of space equivalent to the radius of the door is dedicated to the opening of the door. In contrast, a pocket door is stored within a wall cavity when the door is open.

Typically, pocket-door assemblies are mounted within a rough opening in a non-bearing partition wall, prior to the installation of drywall or another similar wall surface finish. See FIGS. 1A-1C. In such an assembly, the door is typically suspended on a pair of trolley assemblies 182 which ride (roll) in a track 180 disposed on a faming member (e.g. the door header 200). See FIG. 1A. The framing surrounding the door provides a split jamb 300 and corresponding split framing members 220 that create a space within the wall that is somewhat larger than the door thickness and at least as wide as the door panel 500. The pocket door is opened by sliding or rolling the door panel into the pocket created in the wall. See FIG. 1E. To ensure that the door opening will be completely closed by the door, the door panel must be larger than the doorway opening. See FIG. 1D. Only after the pocket door and sliding mechanism is fully assembled in the rough opening and framing pocket are the finish wall surfaces and trim installed.

This type of construction creates a problem when the door must be removed for maintenance or repair. Being both wider and taller than the doorway, the door cannot easily be removed or replaced. Repainting becomes difficult because parts of the door remains within the wall cavity even in when the door is fully closed. Furthermore, the mechanism for rolling the door (i.e. trolleys 182 and track 180) are inaccessible behind the finish surfaces (e.g. drywall 430). As shown in FIG. 2, the pocket does not allow sufficient space to access the sliding mechanism because the space between the door and the split jamb is very narrow, while that on top of the door is insufficient to reach to both sides of the track and both trolleys.

In contrast, bypass sliding doors (often use on closets, in which two or more sliding doors roll on parallel tracks such the one door slides in front of another in a doorway), can be easily removed by lifting and tilting to disengage the trolleys from the tracks. Since bypass closet doors do not slide into a wall cavity, once the trolleys are disengaged, the doors are readily removed from the door opening. Pocket doors, however, cannot be tilted outward because the pocket door panel is wider than the door opening and extend beyond the finish height of the door opening, which further complicates removal for maintenance. Thus, access for repair of sliding mechanisms on pocket doors has generally required removing some of all of the finish dry wall and trim on the wall surfaces enclosing the door's pocket, while removal of door can require demolition of rough framing members as well.

There is thus a need for devices, systems and methods for installing, accessing and removing pocket doors that do not require damage or removal of surrounding wall structures and finishes for maintenance and repair.

### BRIEF DESCRIPTION OF THE DRAWINGS

Other aspects of the present disclosure will become apparent from the following description of embodiments with reference to the accompanying drawings in which:

FIGS. 1A-1E illustrate a conventional pocket door installation. FIG. 1A shows the rough framing of pocket door and installation of track 180 and roller mechanism 182. The door is shown partially cut away to illustrate the split jamb 300. FIG. 1B shows the installed pocket door of FIG. 1A with the finish drywall 430 partially cut away to expose the framing and inaccessible hardware. FIG. 1C. illustrates the pocket door of FIG. 1B in a partially open position and showing the finish drywall 430. FIG. 1D shows the pocket door of FIG. 1C in a closed position, showing the inaccessible hardware in broken lines. FIG. 1F shows the pocket door of FIG. 1C in a fully open position, showing the inaccessible hardware in broken lines.

FIG. 2 is a perspective end view of the pocket door of FIGS. 1C-1F showing the inaccessible track 180 and roller mechanism 182 in broken lines.

FIG. 3 is a perspective view showing the elements of a mounting device according to an embodiment of the invention. Arrows indicate the direction of attachment of elements to each other.

FIG. 4 is a side view of the parts illustrated in FIG. 3.

FIGS. 5A-5F are cross-sectional views of the elements shown in FIG. 4 at planes I-VI indicated by broken vertical lines in FIG. 4. The elements are enlarged relative to their size FIG. 4 to show detail. FIG. 5A is a cross-sectional view through plane I showing hanger channel 12. FIG. 5B is a cross sectional view through plane II showing hanger 20 at plane II. FIG. 5C is a cross sectional view through plane III, showing hanger 20 (illustrating through hole 27), and hanger bolt 10. FIG. 5D is a cross sectional view through plane IV showing connecting rod 40. FIG. 5E is a cross sectional view through plane V showing hanger 20 (illustrating hole 25), and bolt. FIG. 5F is a cross sectional view of through plane VI showing hanger 20 (illustrating tapped hole 23), and bolt 22.

FIG. 6 is a perspective view showing the parts of a mounting device according to an embodiment of invention. Arrows indicate the direction of attachment of elements to each other.

FIG. 7 is a side view of the elements illustrated in FIG. 6.

FIGS. 8A-8C are cross-sectional views of the elements shown in FIG. 7 at planes VII-IX indicated by broken vertical lines in FIG. 7. The elements are enlarged relative to their size FIG. 7 to show detail. FIG. 8A is a cross-sectional view through plane VII showing track 104. FIG. 8B is a cross sectional view through plane VIII showing hanger trolley assembly 30. FIG. 8C is a cross sectional view through plane IX, showing trolley base 32 (without wheels).

FIG. 9A is a cross-sectional view illustrating the complementarity and interlocking of hanger 20 within hanger channel 12. FIG. 9B is an end view illustrating hanger bolt 10 within hanger channel 20. FIG. 9C is an end view illustrating hanger bolt 10 within hanger channel 12.

FIG. 10A shows exemplary shapes of connecting rod channels. FIG. 10B shows exemplary shapes of connecting rod holes.

FIG. 11A-D illustrate the engagement of trolley assembly 30 with track 104. FIG. 11A shows the direction of lifting of the concave rollers 35 of trolley assembly 30 to meet the convex roiling surface 108 of track 104. FIG. 11B illustrates the direction of minimal tilting required to engage trolley assembly 30 with track 104. FIG. 11C illustrates the direction of fully seating the rollers of trolley assembly 30 on rolling surface 108. FIG. 11D shows the fully engaged trolley assembly on track 104.

FIG. 12A is a front perspective view the trolley assembly 30. FIG. 12 B is a rear perspective view of the assembly of trolley assembly 30.

FIGS. 13 A-H illustrate installation of a pocket door hanging system according to the invention. FIG. 13 A shows the unassembled elements of the door hanging system according to the invention. FIG. 13 B shows the engagement of trolley assemblies 30a and 30b with track. FIG. 13 C shows first hanger 20a engaged with first trolley assembly 30a and inserted into track 12. FIG. 13 D shows connection of rod 40 with first hanger 20a. FIG. 13 E shows sliding of first hanger 20a and connected rod 40 into track 12. FIG. 13 F shows second hanger 20b engaged with second trolley assembly 30b. FIG. 13 G shows second hanger 20b connected to rod 40 and rod 40 slid partially into track 12. FIG. 13 H shows the completely assembled hanger assembly and trolleys secured on track 12 with door 500 partially slid through split jamb 300 and into the wall pocket.

FIGS. 14 A-F illustrate removal of a pocket door having a hanging system according to the invention. FIG. 14A shows a partially open pocket door suspended by hangers 20a and 20b which engage trolley assemblies 30a and 30b, respectively, with both trolley assemblies seated on track 12. FIG. 14B shows the partially open pocket door of FIG. 14A with hanger 20b and trolley 30b disengaged and removed allowing the exposed side of the doo to drop to the floor. FIG. 14C shows the partially open pocket door of FIG. 14A with rod 40 disengaged and removed. FIG. 14D shows the partially open pocket door of FIG. 14A with hanger 20a and trolley 30a disengaged and removed allowing the door to drop to the floor. FIG. 14E shows the door, disengaged from the hangers, trolleys and track as it is being rotate out of the door pocket. FIG. 14F shows the pocket door, fully removed from the wall pocket cavity.

### DETAILED DESCRIPTION

The present invention provides mounting devices for use in pocket door and similar structures. The devices and systems of the invention can be removed for repair, replacement, and cleaning. The devices and systems also allow the pocket door panel to be removed from a wall cavity without damaging the finish surfaces of the walls enclosing the pocket door cavity.

In its simplest form the invention provides a channel (hanger channel 12) that is mounted on the top of a door panel 500. A pair of hanger assemblies 18 that connect to rolling trolley assemblies 30, (which can be conventional rolling trolleys or specialized rolling trolleys described herein) through a hanger bolt 10 and roll on a track above the door panel 500 are then engaged within the hanger channel by inserting them into a side of the hanger channel 12, and sliding them into position. Unlike conventional hangers, which may be affixed directly to the door, or may be attached to each other, the hangers of the invention are retained vertically by engagement with the hanger channel 12 and retained laterally by the combination of a connecting rod 40 that securely connects the pair of hangers to form a hanger assembly 18 and a locking bolt 22 that secures the hanger assembly in the hanger channel once it has been slid into place atop the door.

Each part of the hanger assembly is a discrete element, and the elements can be assembled and connected as they are being slid into place in the hanger channel—all from the exposed, out-facing side of the door while all or part of the door remains in the wall cavity or “pocket”. Thus, the elements of the hanger assembly can be installed and removed without accessing the wall cavity (i.e., by removing or at least cutting holes in the finish surface (e.g., drywall)).

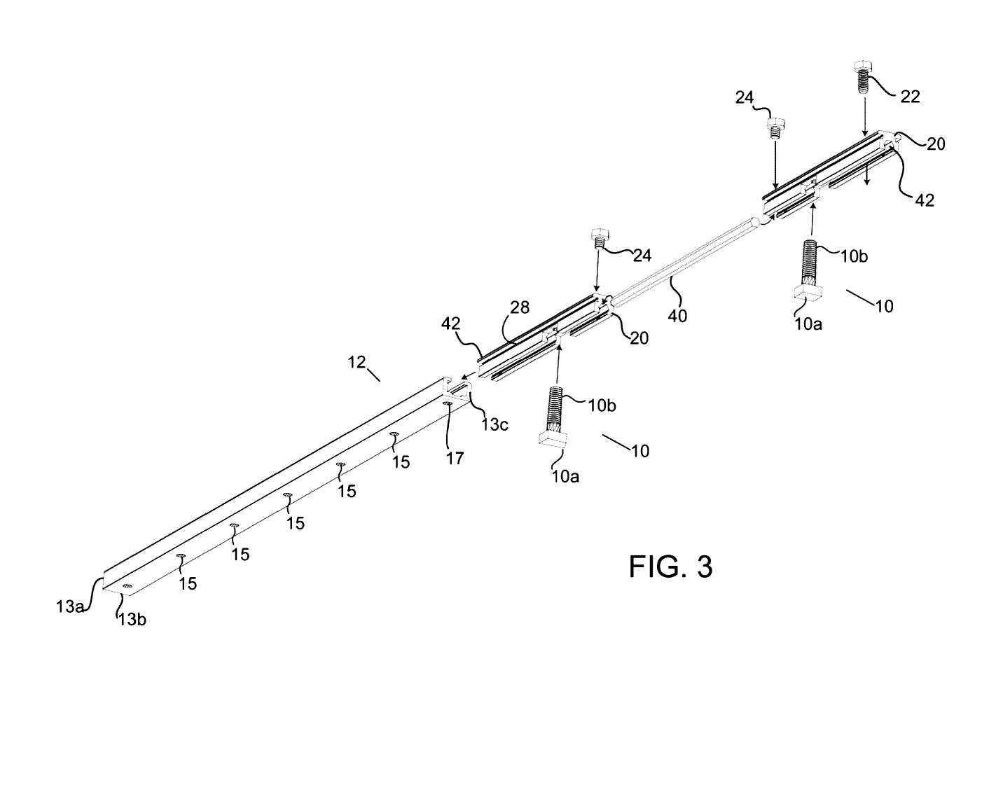

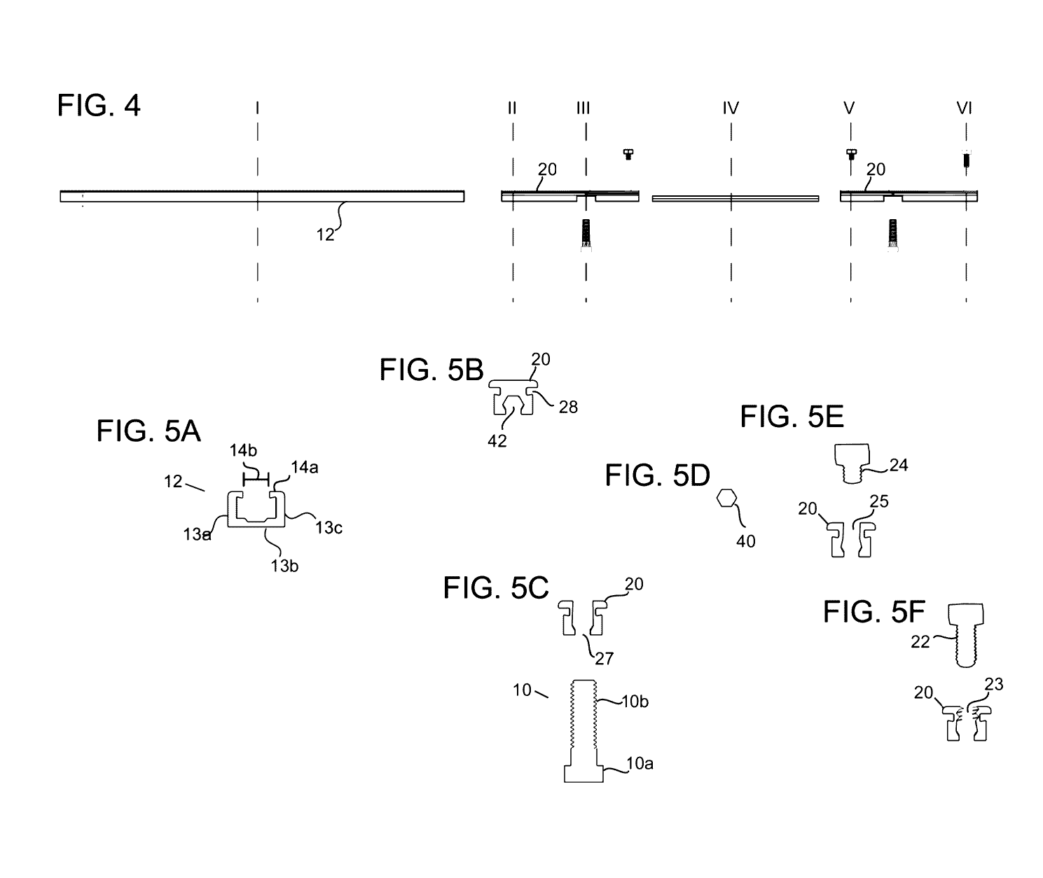

Turning to Figures, the elements of the basic mounting device of the invention are shown in perspective view in FIG. 3, side view in FIG. 4 and various cross sectional views in FIGS. 5A-5F. The device includes a hanger channel 12, which is a longitudinal channel having a generally C shape in cross-section as illustrated in FIG. 5A and FIG. 3. The hanger “C-channel” includes three closed sides 13a, 13b, and 13c, and one open side 14 through which various elements of the hanger 20 extend. The open side 14 includes inwardly facing lips 14a (i.e., partial sides) that are oriented toward the center of the hanger channel open side 14 for engaging and retaining the hanger. The lips flank an open section 14b of side 14.

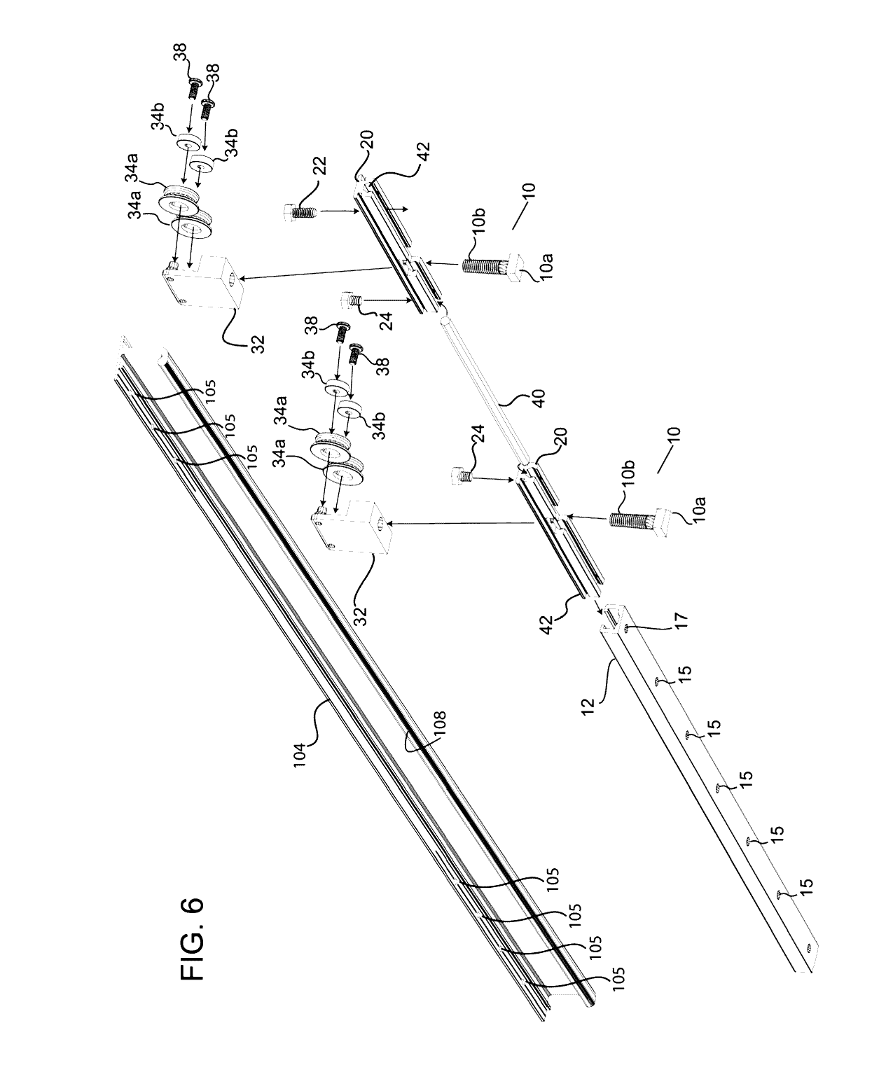

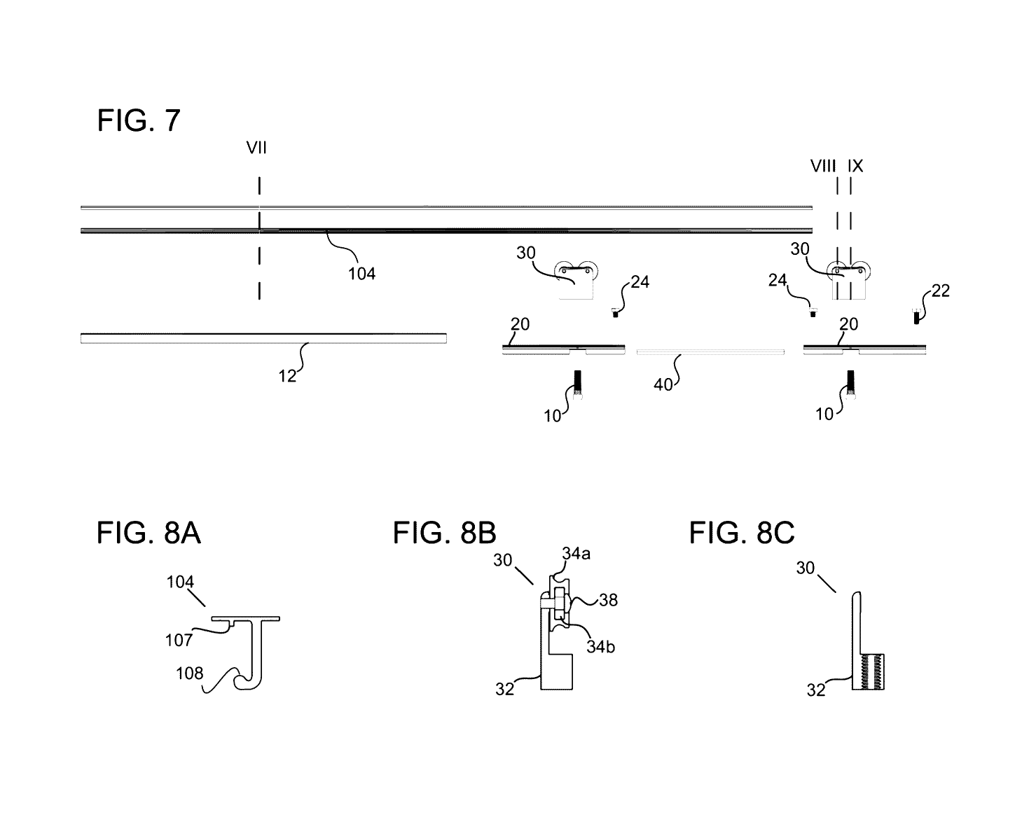

FIG. 6 is a perspective view showing the elements of FIG. 3 and additional elements that can be included with the device. FIG. 7 is a side view of the elements of FIG. 6 and cross sectional views of the additional elements are shown in FIGS. 8A-8C.

The hanger channel can be affixed to the top of a door panel by any means known in the art, such as with fasteners or adhesive, but typically will be a screwed into the top 504 of the door panel 500 using wood screws 16. In certain embodiments of the invention, the hanger channel includes pre-drilled holed for accepting the fasteners, such as wood screws 16. Typically, the outer surface of center closed side 13b of hanger channel 12, which is opposite open side 14, is affixed to a flat top of 104 of a door panel. For additional stability and strength, a dado 502 can be formed in the door top to accommodate the hanger channel.

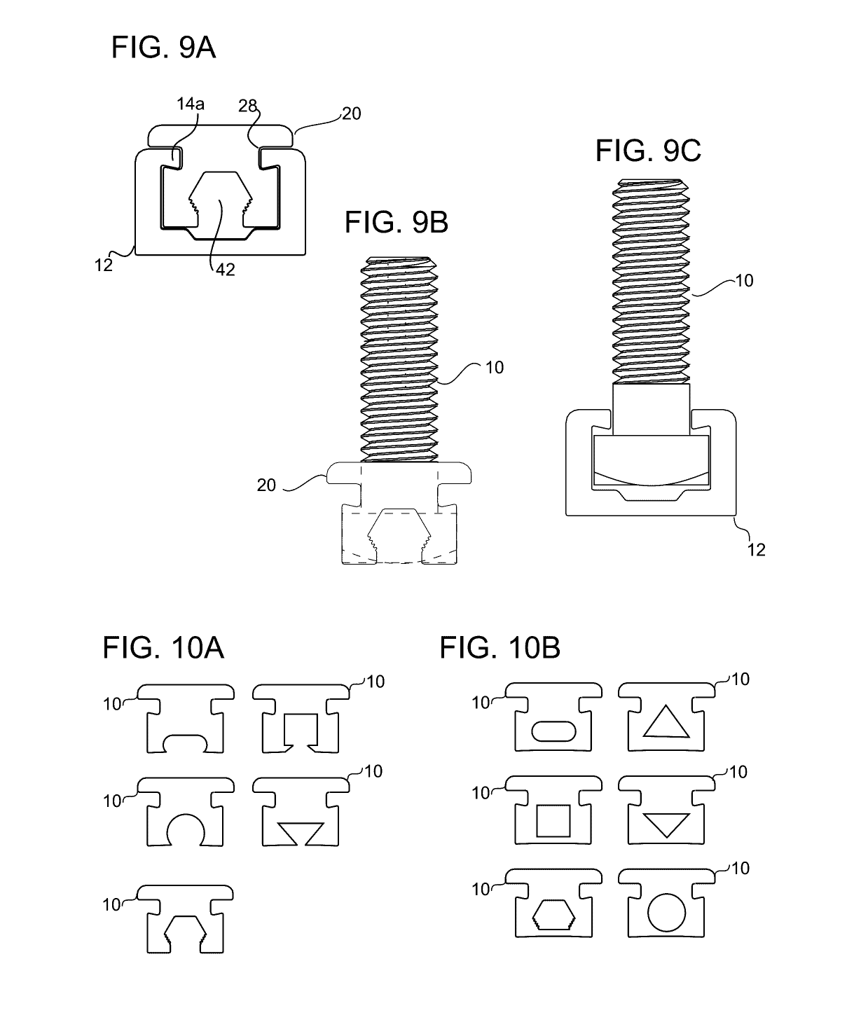

Each of the pair of hangers 20 is a longitudinal element with a cross section complementary to the cross-section of hanger channel 12. See FIG. 9. That is, hanger 20 has a shape and size that is complementary to, fits within and interlocks with hanger channel 12. Hanger 20 has a generally rectangular or polygonal cross section. More specifically, hanger 20 includes grooves 28 on opposing longitudinal sides that engage the inwardly facing lips 14a of hanger channel 12. In certain embodiments, the top of hanger 20 (i.e. portion that extends beyond hanger channel 12 when these two elements are interlocked) is wider than the bottom (i.e. the portion that is retained within hanger channel 12 when these two elements are interlocked) to stabilize and strengthen the top of hanger 20. The interlock supported by the interaction of the lips 14a and grooves 28 ensures that hanger 20 will be retained in the hanger channel 12 when door panel 500 is suspended from the device.

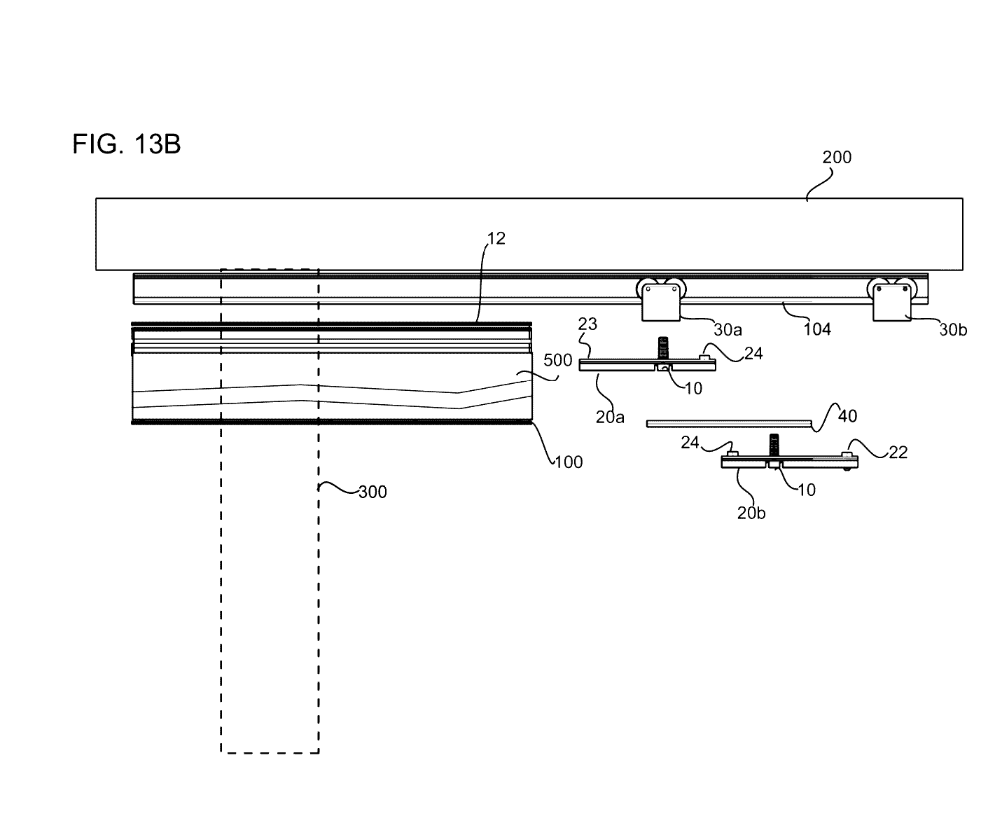

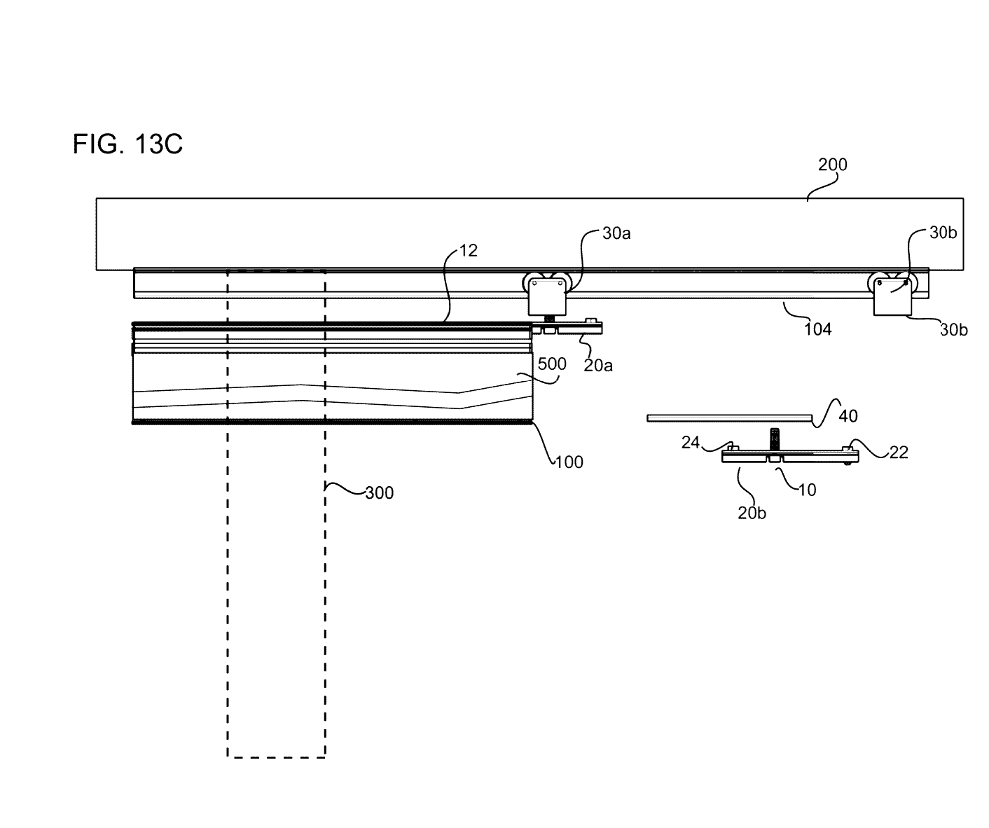

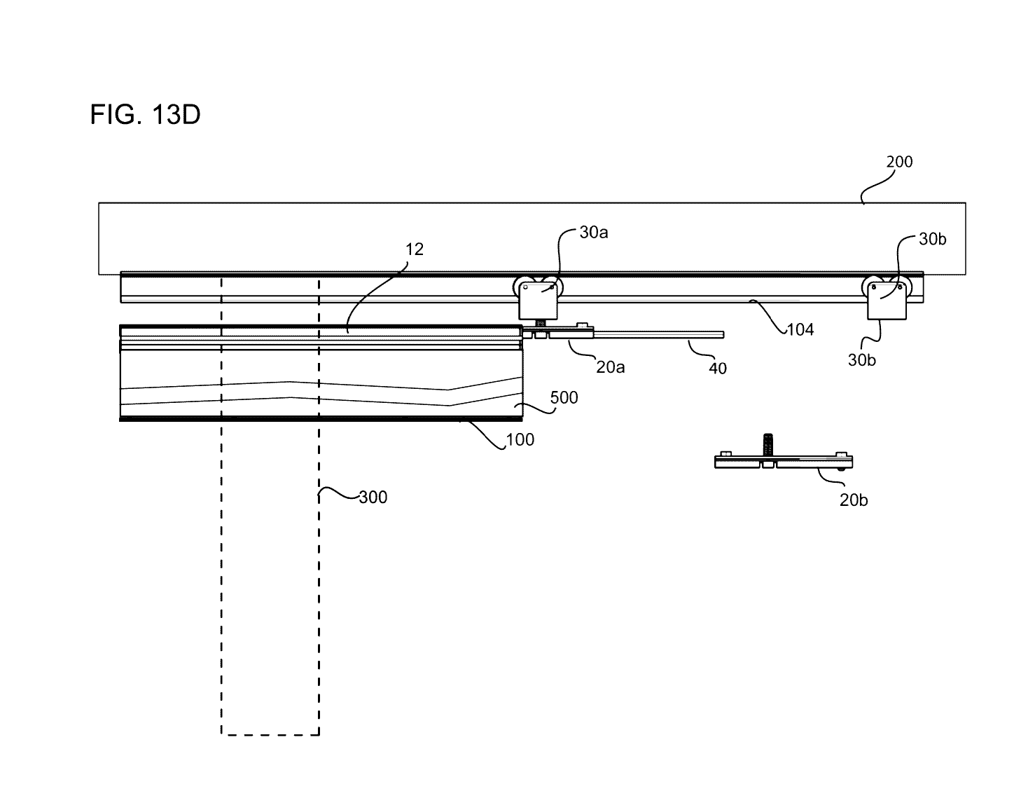

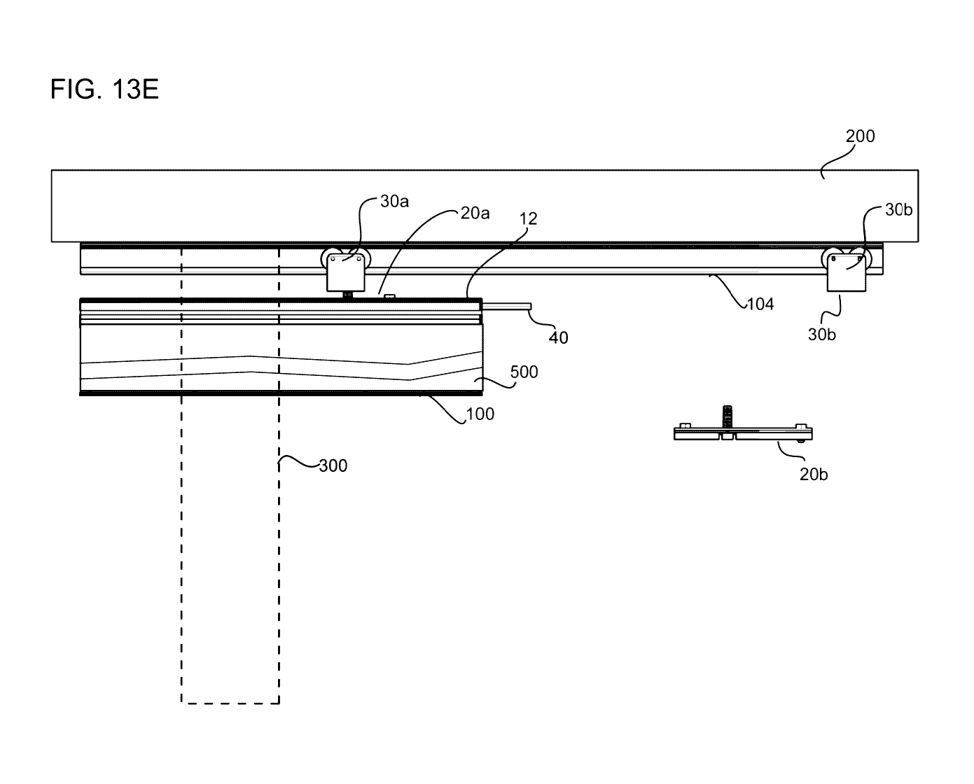

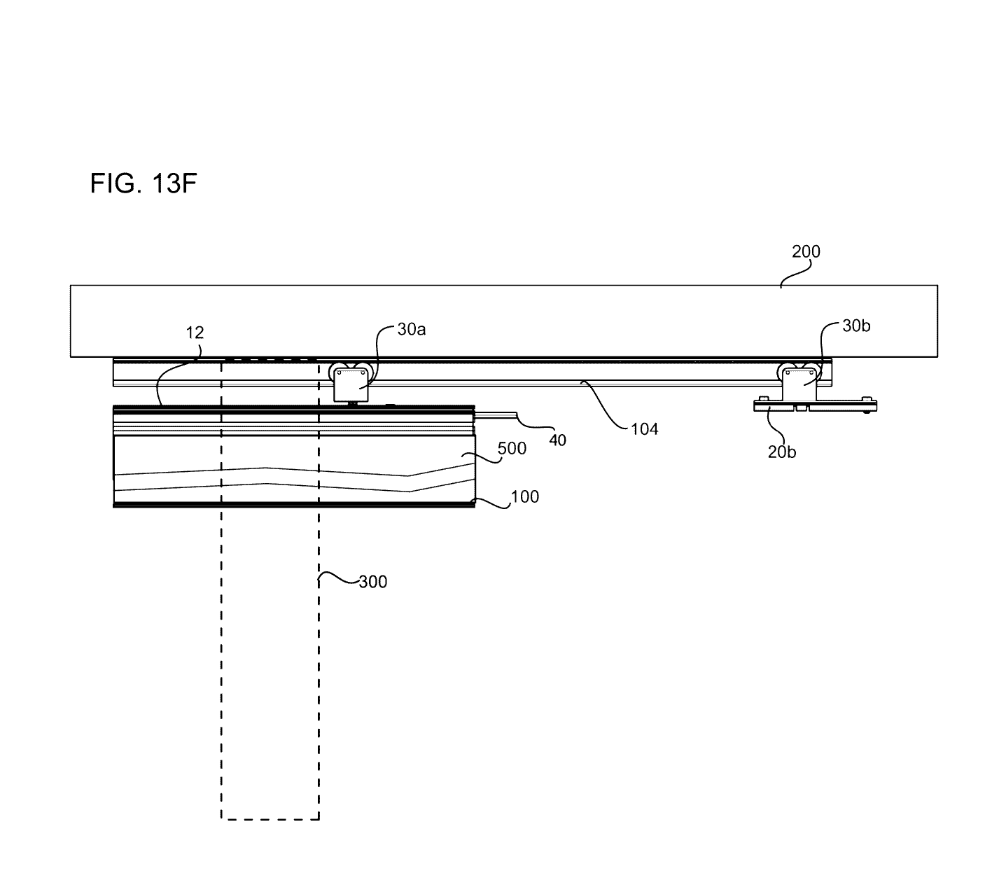

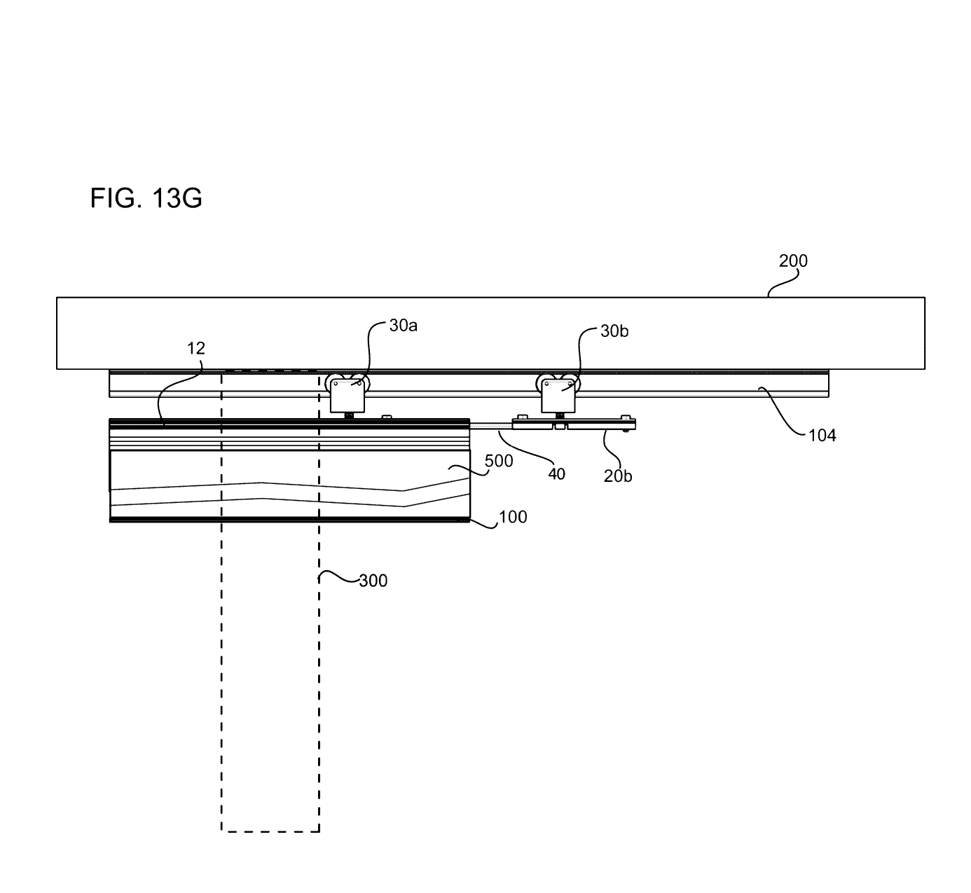

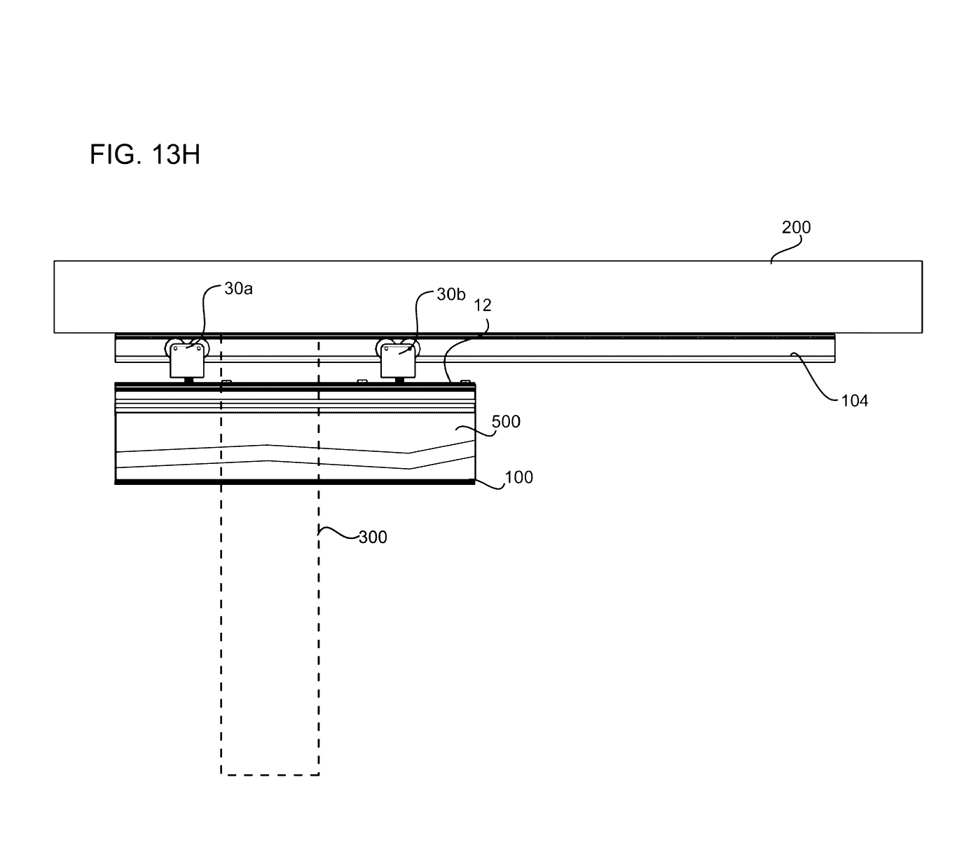

A first end of hanger 20 includes a first hole 23 (see FIG. 13A), which is a tapped through hole in the top of the hanger (i.e., side of the hanger which remains exposed when the hanger 20 is engaged in hanger channel 20) in an orientation perpendicular to the longitudinal axis of hanger 20, for locking hanger 20 in hanger channel 12. Hole 23 is mated to locking bolt 22. When engaged in hanger channel 12, the first end of hanger 20 is slid within hanger channel 12 until a desired position is reached, typically a position in which the first end of hanger 20 reaches the end of hanger channel 12 and the ends are flush with each other. Locking bolt 22 is then engaged in hole 23 and tightened against the hanging channel 12 to prevent hanger 20 from moving by exerting a compressional and/or clamping force that projects through hole 23 to an inner surface of hanger channel 12.

Hanger 20 includes a longitudinal hole or channel 42 for accepting connecting rod 40. This hole or channel can be a through hole traversing the entire length of hanger 20, or it can be a blind hole originating at the second end 20 of hanger 20 and terminating at a point within the hanger 20. It will be appreciated that hole or channel 42 will intersect hanger bolt 10 (when engaged in through hole 27) and terminate at that point. The hole or channel 42 is mated in size and shape to connecting rod 40. Rod 40 can have any cross sectional shape, including circular, heaxagonal, square, triangular and the like. Preferably, rod 40 will have a cross section that resists rotation when engaged in hole or channel 42. For example, hexagonally-shaped rod-channel combination will be less prone to rotation than would a circular rod-channel combination. Furthermore, high-quality steel hexagonally-shaped rods are widely available in various sizes, while other shapes may require custom fabrication. Thus, in certain embodiments, connecting rod 40 has a hexagonal cross section and hole or channel 42 has a mated hexagonal shape.

When hole or channel 42 is a channel, it is advantageous to have an opening of the channel than the maximum width of the channel to provide support needed to secure rod 40 in the channel. Non-limiting examples of cross sectional shapes contemplated for 42 when it is a channel are illustrated in FIG. 10A. Non-limiting examples of cross sectional shapes contemplated for 42 when a hole are illustrated in FIG. 10B.

Hole 25 is disposed through the top of the second end of hanger 20 in an orientation perpendicular to the longitudinal axis of hanger 20. See FIG. 13A. Hole 25 is located near the second end of hanger 20 to avoid waste of materials, but sufficiently distant that that it can withstand the routine motion of sliding the door in and out of the wall cavity without loosening, since the hole or channel will serve to stabilize the rod against such stress. Typically, hole 25 is within 1-3 inches of the second end of the hangers. Hole 25 is mated to rod-locking bolt 24 and engages connecting rod 40 when inserted into hole 25. Tightening rod-locking bolt 24 against rod 40 within hole 25 locks the rod in place by compression and clamping the rod against the internal surfaces of the hanger 20.

Connecting rod 40 serves several purposes. It links together two hangers 20, thereby providing strength and rigidity to the mounting device. Furthermore, rod 40 allows customization of the overall length of the mounting device to the actual width of a door or other hanging structure. More importantly, including detachable rod 40 to link two hangers 20 allows each of these three longitudinal elements (two hangers separated by a rod) of the hanger assembly 18 to be installed on top of a door panel 500 independently and sequentially. The first end of the first hanger 20a is inserted into hanger channel 12 and secured to custom-cut connecting rod 40 with rod-locking bolt 24. The first hanger 20a and rod 40 are then slid further into hanger channel 12, leaving the unconnected end of rod 40 accessible for securing to the second end of the second hanger 20b. Once the rod is locked into the second hanger 20b, the assembly is then slid further into the hanger channel until the first end of the second hanger 20b is flush with the exposed end of the hanger channel 12, and then hanger assembly 18 (including the first and second hanger 20a and 20b, connected by connecting rod 40) is locked into place in hanger channel 12 with locking bolt 22 as described above.

Each hanger also includes through hole 27 between hanger assembly locking hole 23 and connecting rod locking hole 25. Hole 27 is approximately in the center of each hanger 20, or within the center third of hanger 20 lengthwise, in an orientation perpendicular to the longitudinal axis of hanger 20, for accepting hanger bolt 10. Hanger bolt 10 has a threaded shank 10a, and a rectangular or polygonal head 10b. See FIGS. 3, 6 and 9B-C. Shank 10a engages a tapped hole 36 rolling trolleys (described below), thereby suspending door panel 500 from hanger 20 as detailed below in a slidable or rollable (i.e., moves on rollers) fashion. Hanger bolt head 10b engages within and is retained non-rotatably by hanger 20, which in turn, engages in hanger channel 12 thereby preventing hanger bolt 10b from slipping out of the hanger, as illustrated in FIGS. 9A-9C. Shank 10a of hanger bolt 10 is inserted into the bottom of hanger 20 and projects outwardly (upwardly) through hole 27. When partially inserted in hole 27, hanger bolt 10 can freely rotate and thereby engage the tapped hole 36 of a trolley base 32. However, the square or polygonal head 10b of hanger bolt 10 cannot rotate when fully seated in hanger 20 and hanger 20 is secured in hanger channel 12, thereby preventing disengagement of an attached rolling trolley assembly 30. Bolt 10 can be any size, but is conveniently a standard size used for hanging pocket doors and similar structures on trolleys that engage and roll or slide on tracks. Standard sized bolts thus facilitate retrofitting existing pockets with new doors without removal of the suspended track to which the trolleys engage.

In certain embodiments, the mounting devices of the present invention also include rolling trolley assemblies 30 and tracks 104 on which the trolley assemblies 30 roll. The trolley assemblies 30 each include a trolley base 32, one or more rollers 34 and a tapped hole for accepting and engaging the threads of the mated hanger bolt 10. A variety of rolling trolleys that are known in the art may be suitable for use in the invention mounting device, including trolleys that roll on single tracks, double tracks and trolleys that include rollers that straddle double sided tracks. In the close confines of a wall pocket, however, there is little space to install or remove trolleys. Since many trolleys that engage with multiple tracks require tilting and turning of the trolley to engage the tracks, single-sided tracks and those that can engaged with minimal tilting are preferred.

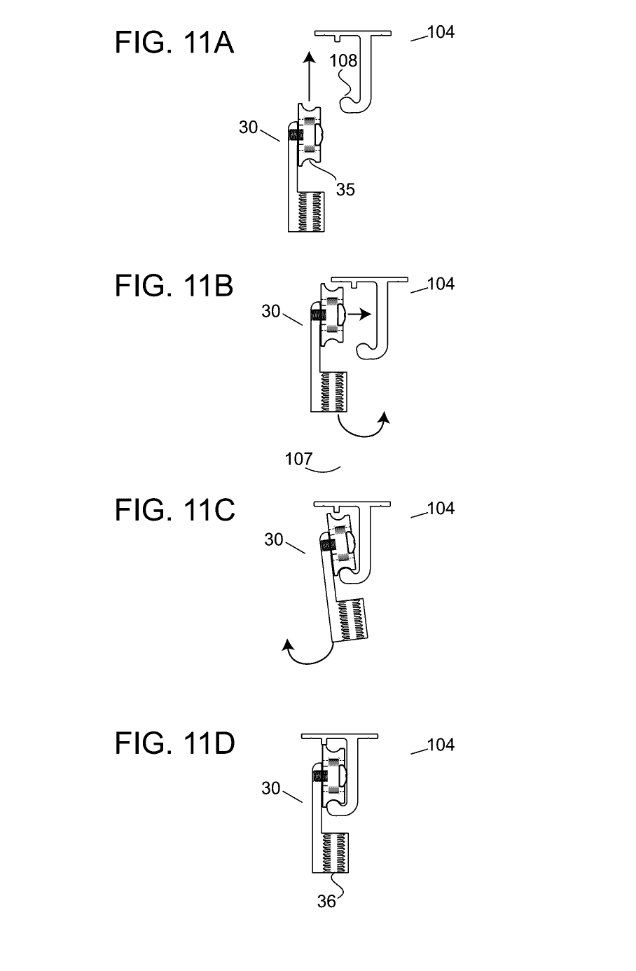

The present invention obviates much of the problem of tilting a door panel when such tilting is required to engage the rolling trolleys 30 on a track 104 by allowing the trolleys 30 to be engaged before they are attached to the door 500. The tilting required of the trolleys 30 alone is readily accommodated in the narrow confines of a pocket door wall cavity as illustrated in FIGS. 11A-D. The concave shape of the rollers 34 and trolley retaining flange 108 prevent the trolleys from becoming displaced during use. See FIGS. 11A-11D.

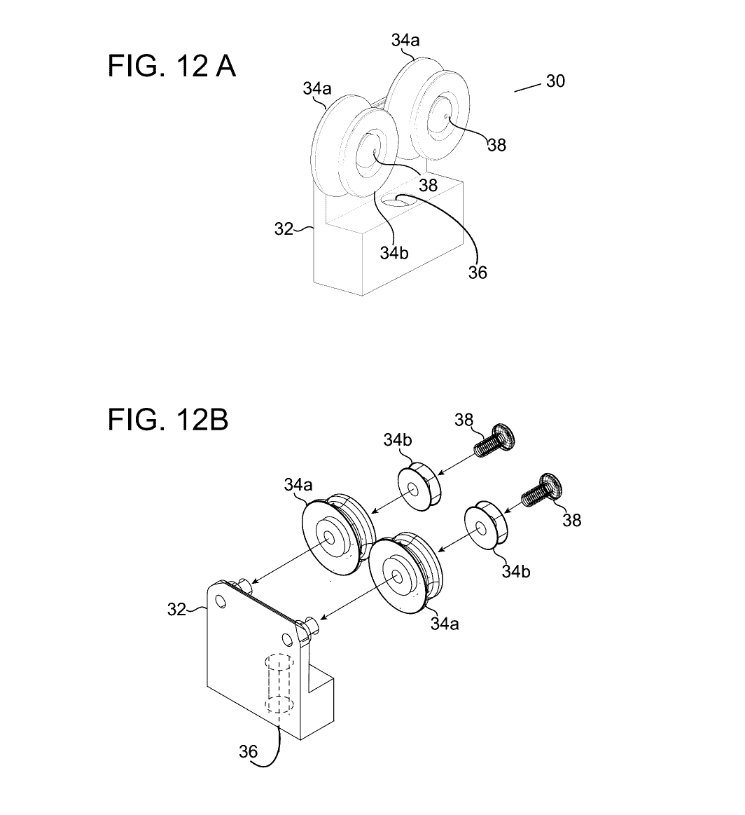

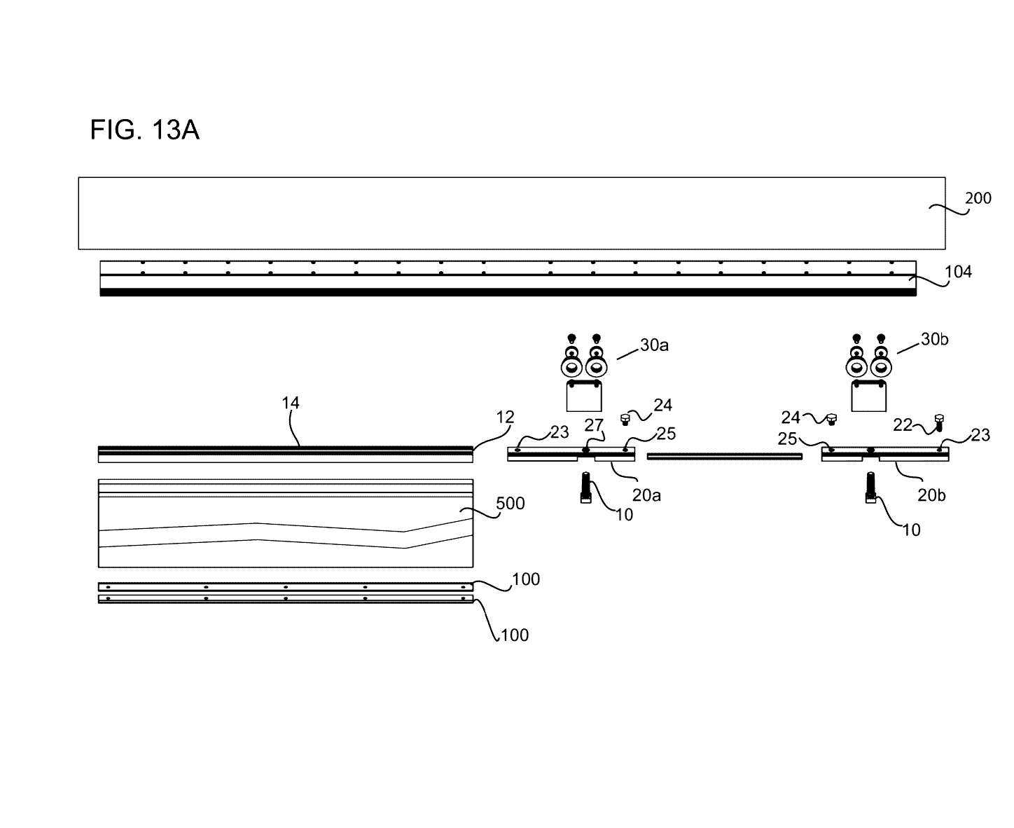

The present invention provides trolley assemblies 30 in which a pair of rollers 34 are disposed on the same side of trolley base 34 and do not require tilting after attachment to a door panel to install on a track. In certain aspects, the rollers 34 of the trolley assemblies 30 of the invention are wheels having a concave rolling shape 35. FIG. 11A. Such trolley assemblies can be engaged with a track 104 having a convex rolling surface 108 by lifting the trolley assembly 30 above the rolling surface 35 of the track (FIG. 11A), and lowering it onto the track (as illustrated in FIGS. 11B-11C) such that the convex rollers 34 sit on the convex track rolling surface 35 as shown in FIG. 11D. The rollers can be made of any suitable material as will be appreciated by the skilled artisan, such as hard rubber, polymer, phenolic, polyurethane, or metal; for interior use, a resilient material such as nylon, neoprene, silicone or soft rubber may be preferred to reduce the noise of the rollers moving on the track. In certain aspects of the invention the rollers 34 include two parts: a more durable center wheel 34b made from e.g., metal or a hard plastic; and a resilient outer rolling surface 34a that muffles noises when rolling on a track, as illustrated in FIG. 12B. Such two-part rollers or wheels can be removably attached to the trolley base 32 with a screw (e.g., 38), pin, cam or other connecting mechanism known to those skilled in the art.

The trolley assemblies 30 according to the invention also include a tapped through hole 36 that engages the hanger bolt 10. FIGS. 12A and B. Trolley base 30 has an L shaped cross section that allows the wheels to be offset from the through hole 36, which hole 36 is centered between the rollers 34. This configuration allows hanger bolt 10 to be raised or lowered (by screwing it in or out) over a much wide range of heights since the bolt 10 can extend beyond the top of the through hole 36.

In certain embodiments of the invention, track 104 has a J shape cross section with a convex rolling surface 108 disposed on the apex of the curve. Other shapes may be suitable for use with the mounting devices and systems of the invention, particularly those with a single convex rolling surface 108 disposed on one side of the track 104. The top of the J shape or an equivalent can include pre-drilled holes for accepting fastening screws 106 for attaching the track 104 to a rough framing member, e.g., a door header. Alternative methods for attaching track such as adhesives or other fasteners will be known to the skilled artisan.

Also provided by the invention are systems for hanging a sliding door, such as a pocket door, comprising a mounting device as described herein, a door panel 500, and a pair of longitudinal bottom door guide rails 100. According to certain embodiments of the invention, the bottom side 13b of the hanger channel (opposite the open side) is affixed to the top of the door panel (e.g. using screws or adhesive) and the longitudinal bottom door guide rails 100 are affixed to opposing edges of the bottom of the door panel (e.g. using screws or adhesive). The bottom guide rails obviate the need for shoe or other guide rails located with the wall cavity by maintaining a space between the bottom of the pocket door panel and the rough or finish members of the doorway and pocket. In certain aspects of the invention, the top of door panel 500 includes a dado spanning the width of the door for engaging the hanger channel 12. In some embodiments, screw holes may be predrilled in hanger channel 12, bottom door guide rails 100 and track 104 to facilitate installation.

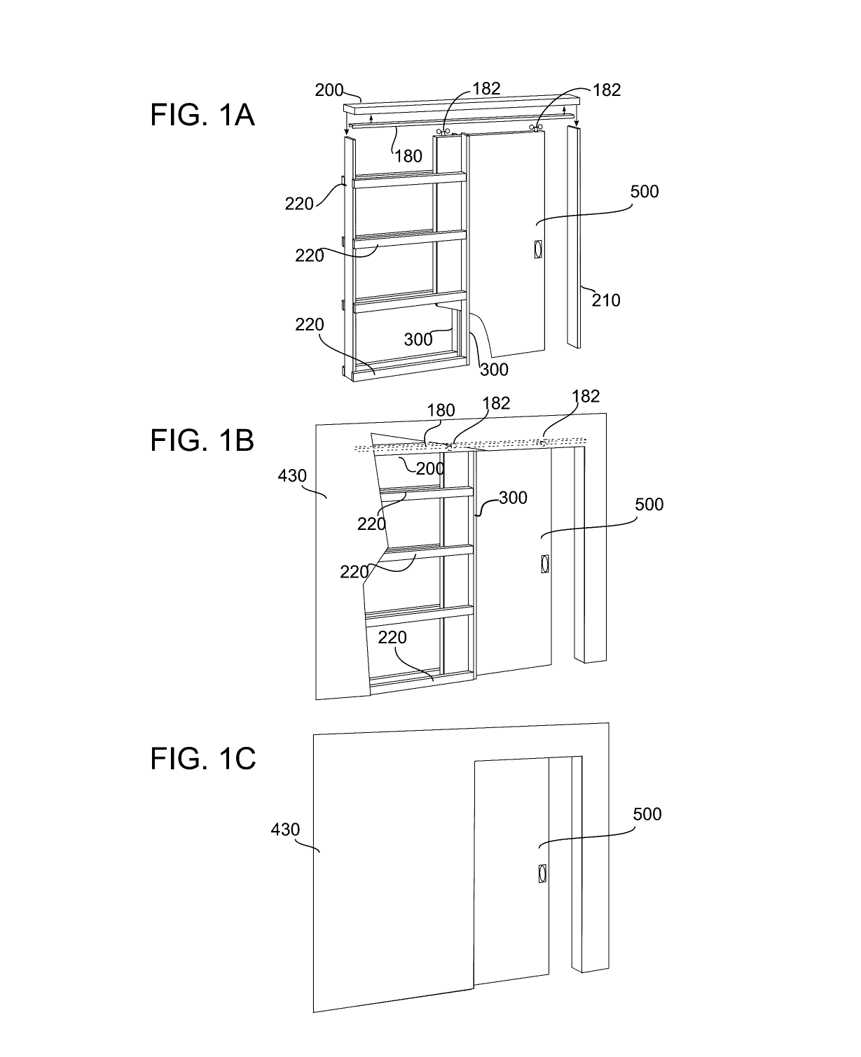

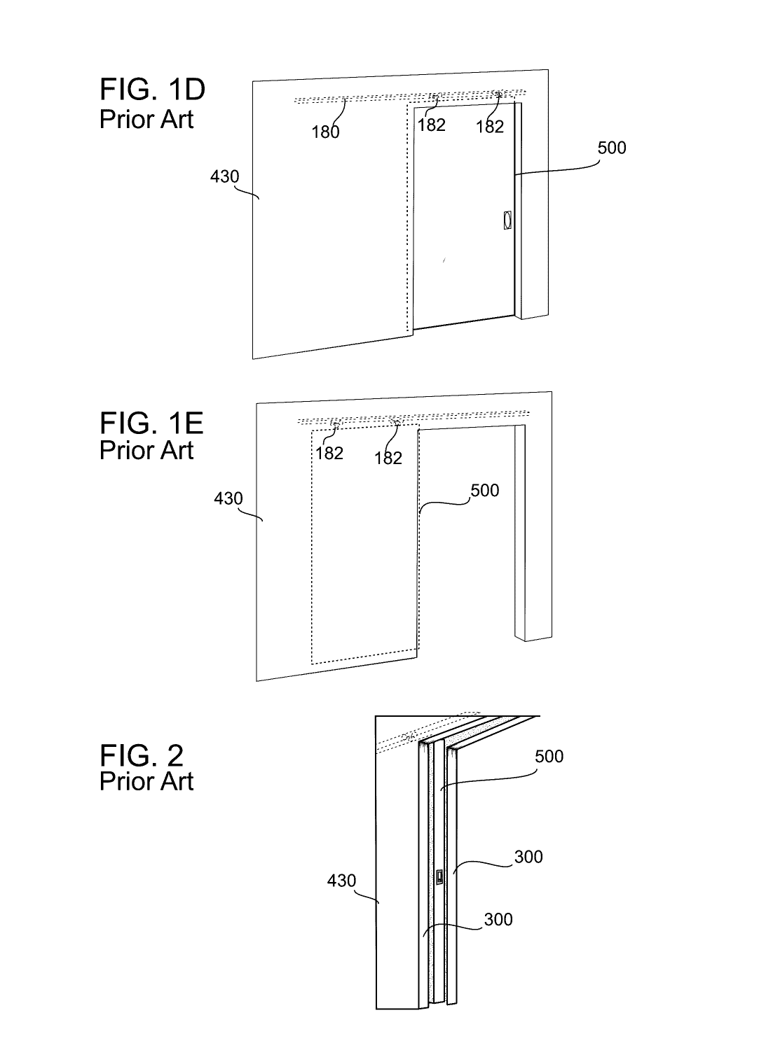

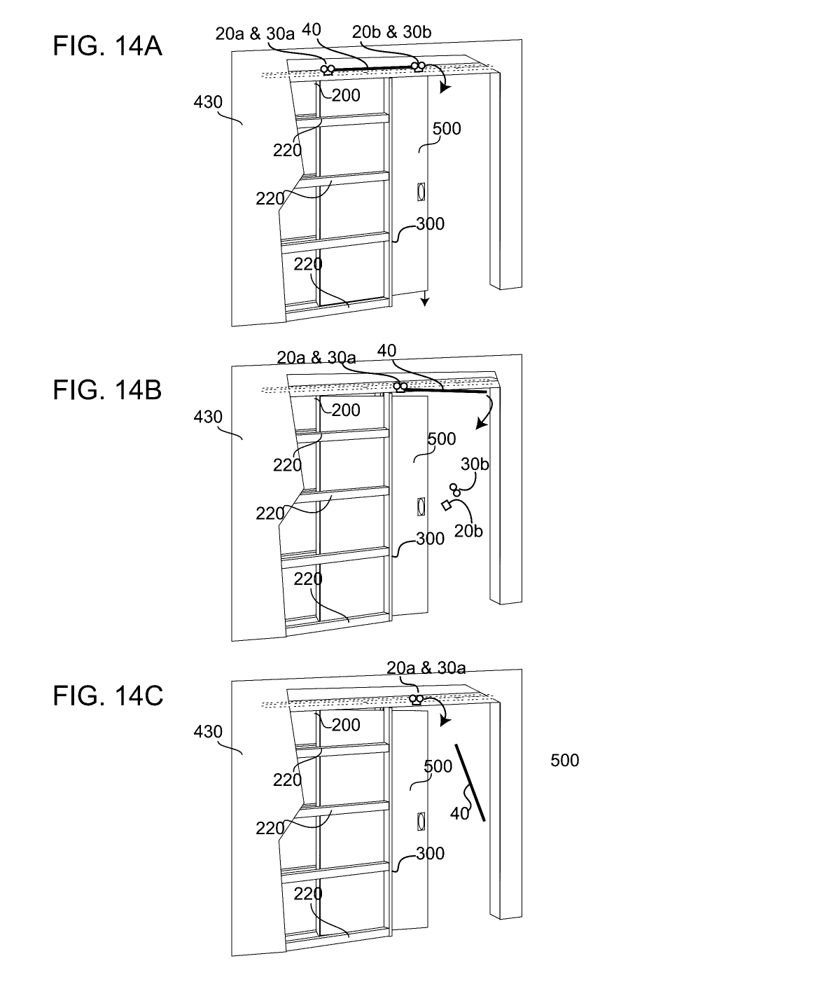

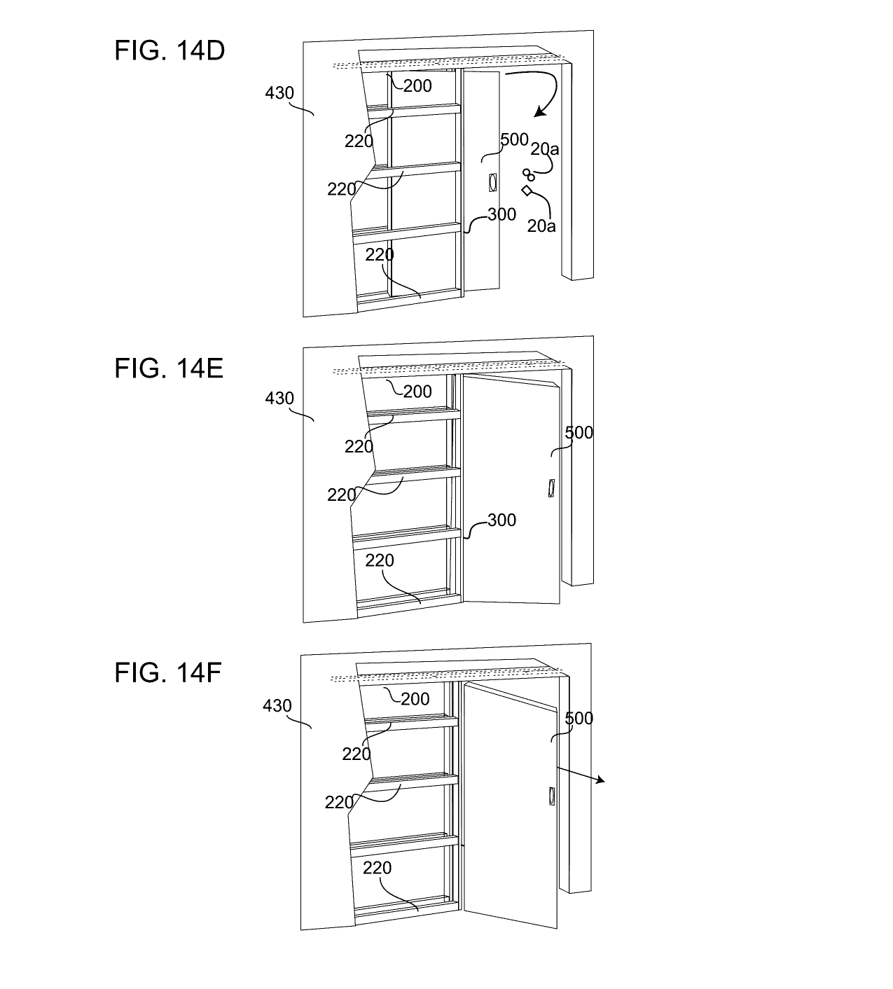

In certain aspects of the invention, the system includes a door header 200 and split jam framing rough-in forming a wall cavity (as illustrated in FIGS. 1A, 1B, and 14A-F), where the track is affixed to the bottom of the door header 200 and door panel 500 is inserted between the split jam 300, and slides into a wall cavity. Such systems may be sold as pre-hung units that can be installed during the rough-in stage of construction.

Also provided by the invention are methods for installing a pocket door as illustrated in FIGS. 13 A-E, comprising the steps of providing a system for hanging a sliding door described herein; affixing track 104 to the bottom of the door header 200 with the rolling surface accessible; affixing hanger channel 12 to the top of door panel 500 with the open side 14 facing track 104; affixing the bottom guide rails 100 to the bottom edges of the door panel; assembling rolling trolley assemblies 30a and 30b; engaging the concave rolling surfaces 35 of the rollers 34 on the trolley assemblies 30a and 30b with the convex surface 108 of track 104; placing the door panel 500 through the split jamb 300 and partially into the wall cavity; inserting one of the hanging bolts 10 through the first hanger 20a and screwing hanging bolt 10 into tapped hole 36 of the first trolley assembly 30a and adjusting the height of the door panel by adjusting the extent hanging bolt 10 is screwed into tapped hole 36; inserting a first end of connecting rod 40 into the hole or channel 42 into second end 20b of the first hanger 20 and securing the rod in the first hanger 20a with the rod-locking bolt 24; inserting the first end of the first hanger 20a into hanging channel 12 and sliding it into the channel leaving the free end of the connecting rod outsider the channel 12; inserting the second hanging bolt 10 through the second hanger 20b and screwing the second hanging bolt into tapped hole 36 of the second trolley 32b and adjusting the height and level of the door panel; inserting the free end of connecting rod 40 into the hole or channel 42 through the second end of the second hanger 20 and securing the rod 40 in the second hanger with the rod-locking bolt 24; inserting the second end of the second hanger 20 into hanging channel 12 and sliding the second hanger in the hanging channel until the first end of the second hanger 20b is flush with the end of track 10; inserting locking bolt 22 through the tapped 23 hole in the first end of the second hanger 20a, and tightening the locking bolt 22, thereby securing the hanger assembly in the hanger channel; thereby installing a pocket door.

In certain embodiments, track 104 is preinstalled during the rough in stage of construction of the pocket door and the remaining steps are performed after finish surfaces have been installed on the outside of the wall cavity.

Thus, the invention also allows removal of a pocket door without damaging the finish surfaces as illustrated in FIGS. 14A-14F. According to this method of the invention, the pocket door is partially opened and the locking bolt 22 is removed, thus disengaging hanger assembly 18 from the hanger channel 12. The second hanger 20b is then slid out of the hanger channel 12 and disengaged from the connecting rod 40 by removing rod-locking bolt 24. The hanger bolt of the second hanger is then uscrewed from the attached trolley assembly 30b, thereby disengaging the second hanger, and allowing the side of the door panel to which the second hanger was engaged to drop to the floor. The connecting rod 40 is then slid out of hanging channel 12 and rod-locking bolt 24 securing the first hanger to the connecting rod is removed, thereby disengaging the rod 40, which is then removed from the hanger channel 12. The first hanger 20a is then slid out of the hanging channel 12 and hanger bolt 10 is unscrewed, thereby disengaging the first hanger 20a from the attached trolley assembly 30a and allowing the side of the door panel to which the first hanger was engaged to drop to the floor. The door panel can then be rotated out of the pocket such that the exposed side of the door is moved away from the door opening while moving the door panel out of the wall cavity, until the door can completely removed from the wall cavity, thereby removing the pocket door panel from the finished wall cavity.

What is claimed is:

1. A mounting device comprising:
a) a longitudinal hanger channel having a C shape cross-section, the cross section including three closed sides and a fourth, partially open side comprised of opposed, inwardly oriented lips with an open section therebetween, and having a tapped hole for engaging a positioning bolt disposed through one end of the hanger channel on the side opposite the fourth, partially open side; and
b) a hanger assembly comprising:
i) a pair of hanger bolts, each hanger bolt having a threaded shank and a rectangular or polygonal shaped head;
ii) a first longitudinal hanger and a second longitudinal hanger, each hanger having:
(1) a cross section complementary to the cross section of the longitudinal hanger channel;
(2) a pair of longitudinal grooves disposed on opposing outer sides for engaging the inwardly oriented lips of the hanger channel, such that each hanger can be slidably inserted into an end of the hanger channel, wherein the longitudinal grooves engage the inwardly oriented lips of the hanger channel and the hanger s can be slid along the length of the hanger channel;
(3) a first, tapped hole disposed through a first end of the hanger in an orientation perpendicular to the longitudinal axis of the hanger and mated to a locking bolt that may be inserted therethrough;
(4) a second hole disposed in an orientation perpendicular to the longitudinal axis of the hanger, through a second end of the hanger opposing the first end, mated to a connector-tightening bolt inserted therethrough,
(5) a third hole disposed between the first and second holes in an orientation perpendicular to the longitudinal axis of hanger for accepting one of the hanger bolts inserted therethrough, wherein the head of the hanger bolt is retained within the hanger and the threaded shank of the hanger bolt projects through the third hole and through the open section of the hanger channel when the hanger is inserted into the hanger channel; and
(6) a longitudinal connector hole or channel for accepting a connecting rod inserted therein, wherein the connector hole or channel is a through hole or channel traversing the length of the hanger, or is a blind hole or channel originating at the second end of the hanger, terminating within the hanger and intersecting the second through hole;
c) a connecting rod that connects the second end of the first longitudinal hanger to the second end of the second longitudinal hanger by engaging the longitudinal hole or channel of each hanger when inserted therein;
d) a pair of rod-locking bolts inserted through the second holes of the first and second hangers, wherein each rod-locking bolt secures an opposing end of the connecting rod inserted in the longitudinal hole or channel of one of the hangers; and
e) a locking bolt that is inserted into the first, tapped hole of the second hanger and engages the hanger channel, thereby locking the hanger assembly in the hanger channel;
wherein the first end of the first hanger is inserted into and slidably received within the hanger channel; the second end of the first hanger is engaged with an end of the connecting rod and the connecting rod slid into the hanger channel; the opposite end of the connecting rod is engaged with the second end of the second hanger, which second hanger is then inserted into the hanger channel and slidably received within the hanger channel until the first end of the second hanger is aligned with the end of the hanger channel through which the hangers and rod were inserted, and the hanger assembly is secured by inserting and tightening the locking bolt in the first, tapped hole of the second hanger.

2. The mounting device of claim 1, wherein the connecting rod has a hexagonal cross section and the hole or channel in the hanger has a mated hexagonal cross section, thereby preventing the connecting rod from rotating when inserted into the hole or channel.

3. The mounting device of claim 1, wherein the longitudinal hanger channel further comprises through holes disposed through the side opposite the open side, for accepting fastening screws inserted therethrough.

4. The mounting device of claim 1, further comprising:
f) a pair of rolling trolley assemblies, each rolling trolley assembly including
i) a trolley base;
ii) a pair of a rollers, each roller having a concave rolling surface, and
iii) a tapped hole that engages the threads of one of the hanger bolts,
wherein the tapped hole is centered between the rollers on the rolling trolley; and
g) a longitudinal track comprising a convex rolling surface,
wherein the concave rolling surface of each roller engages with the convex rolling surface of the track.

5. The mounting device of claim 4, wherein each rolling trolley is engaged with the convex rolling surface of the track prior to engaging the hanger bolts with the tapped hole in the trolley.

6. The mounting device of claim 2, wherein the track has a J shape cross section and the convex rolling surface is disposed on the terminus of the curved portion of the J shape.

7. The mounting device of claim 6, wherein the horizontal arms on the top of the J shape includes through holes for accepting fastening screws inserted therethrough.

8. A system for hanging a sliding door, comprising:
a) the mounting device of claim 4;
b) a door panel; and
c) a pair of longitudinal bottom door guide rails,
wherein the side of the hanging channel opposite the open side is affixed to the top of the door panel, and the longitudinal bottom door guide rails are affixed to opposing edges of the bottom of the door panel.

9. The system of claim 8, wherein the side of the hanging channel opposite the open side comprises through holes and is affixed to the top of the door panel with screws inserted though the through holes.

10. The system of claim 8, wherein the top of the door panel comprises a longitudinal dado into which the mounting channel is affixed.

11. The system of claim 8, wherein the bottom door guide rails comprise through holes and are affixed to the bottom of the door panel with screws that engage the bottom of the door panel.

12. The system of claim 8, further comprising:
d) a door header; and
e) a split jam framing rough-in forming a wall cavity,
wherein the track is affixed to the bottom of the door header and the door panel is inserted between split jam and slides into the wall cavity.

13. A method for installing a pocket door comprising:
a) providing the system of claim 8;
b) affixing the track to the bottom of the header such that the rolling surface can be engaged by the rolling trolleys;
c) affixing the hanging channel to the top of the door panel with the open end facing track the track;
d) affixing the bottom guide rails to the bottom edges of the door panel;
e) engaging the concave rolling surfaces of the rollers on the trolleys with the convex surface of the track;
f) placing the door panel through the split jamb and partially into the wall cavity;
g) inserting one of the hanging bolts through the first hanger and screwing the hanging bolt into tapped hole of the trolley closest to the wall cavity;
h) inserting a first end of the connecting rod into the hole or channel of the second end of the first hanger and securing the rod in the first hanger with a rod-locking bolt;
i) inserting the first end of the first hanger into the hanging channel and sliding it into the channel leaving the free end of the connecting rod outside the channel;
j) inserting the second hanging bolt through the second hanger and screwing the second hanging bolt into tapped hole of the trolley furthest from the wall cavity;
k) inserting the free end of connecting rod into the hole or channel through the second end of the second hanger and securing the rod in the second hanger with a rod-locking bolt;
l) sliding the second hanger into the hanging channel until the first end of the second hanger is flush with the end of hanger channel through which the hangers and connecting rod were inserted; and
m) inserting the locking bolt through the tapped hole in the first end of the second hanger and tightening the locking bolt, thereby securing the hanger assembly in the hanger channel;
thereby installing a pocket door.

14. The method of claim 13, wherein steps f) through m) are performed sequentially.

15. The method of claim 13, wherein the track is installed prior to installing finish surfaces on the outside of the wall cavity.

16. The method of claim 15, wherein steps f) through m) are performed after finish surfaces have been installed on the outside of the wall cavity.

17. A method for removing a pocket door panel from a finished wall cavity comprising:
a) providing a pocket door installed in a finished wall cavity according to claim 13;
b) partially opening the door panel;
c) removing the locking bolt;
d) sliding the second hanger out of the hanging channel;
e) removing the rod-locking bolt securing the second hanger to the connecting rod;
f) unscrewing the second hanger from the second trolley, thereby disengaging the second hanger, and thereby allowing the exposed side of the door panel to which the second hanger was engaged to contact the floor;
g) sliding the connecting rod out of the hanging channel and removing the rod-locking bolt securing the first hanger to the connecting rod, thereby disengaging the rod;
h) sliding the first hanger out of the hanging channel and unscrewing the first hanger from the first trolley, thereby disengaging the first hanger allowing the side of the door panel to which the first hanger was engaged to contact the floor; and
i) rotating the door such that the exposed side of the door is moved away from the door opening, while moving the door panel out of the wall cavity until the door panel is completely removed from the wall cavity;
thereby removing the pocket door panel from the finished wall cavity.
